(19) United States
(12) Patent Application Publication
(10) Pub. No.: US 2015/0276932 A1
(43) Pub. Date: Oct. 1, 2015

(54) APPARATUS AND METHOD FOR DETERMINING LOCATION OF MOBILE OBJECT

(71) Applicant: ELECTRONICS AND TELECOMMUNICATIONS RESEARCH INSTITUTE, Daejeon (KR)

(72) Inventors: Kye-Seon LEE, Daejeon (KR); Jae-Hong RYU, Sejong (KR); Jae-Heum LEE, Daejeon (KR); Byeong-Cheol CHOI, Daejeon (KR); Nae-Soo KIM, Daejeon (KR)

(21) Appl. No.: 14/666,829

(22) Filed: Mar. 24, 2015

(30) Foreign Application Priority Data
Mar. 26, 2014 (KR) 10-2014-0035413

(51) Int. Cl. G01S 19/03; G01S 1/04

(52) U.S. Cl. CPC G01S 19/03; G01S 1/04

(57) ABSTRACT

An apparatus and method for determining the location of a mobile object are disclosed. The apparatus includes a GPS module unit, a mobile communication module unit, a USN module unit, and a control module unit. The GPS module unit receives a GPS signal including the coordinate information of the current location of a mobile object. The mobile communication module unit is operated when the GPS module unit has received the GPS signal, and transmits the coordinate information of the current location of the mobile object and the ID of the mobile object to a location estimation apparatus. The USN module unit is operated when the GPS module unit fails to receive the GPS signal, and broadcasts a beacon signal carrying the ID of the mobile object. The control module unit operates any one of the mobile communication module unit and the USN module unit.

### CROSS-REFERENCE TO RELATED APPLICATION

This application claims the benefit of Korean Patent Application No. 10-2014-0035413, filed Mar. 26, 2014, which is hereby incorporated by reference herein in its entirety.

### BACKGROUND

1. Technical Field

The present disclosure relates generally to an apparatus and method for determining the location of a mobile object and, more particularly, to an apparatus and method that are capable of supporting the determination of the location of a mobile object (for example, a wild animal) in a shadow area where a global positioning system (GPS) signal cannot be received.

2. Description of the Related Art

When a mobile object (for example, a wild animal) to which a GPS terminal for determining a location has been attached enters a shadow area where a GPS signal cannot be received, it is impossible to determine the location of the mobile object.

As an example, a case where a terminal in which a GPS reception module and a mobile communication transmission module have been mounted is attached in order to determine the path of a wild animal is described. The terminal transmits coordinate information, received from the GPS reception module, to a location estimation apparatus via the mobile communication transmission module at regular time intervals. The location estimation apparatus estimates or tracks the path of a wild animal using the coordinate information collected from the terminal.

The method of attaching a terminal into which a GPS function and a mobile communication function have been combined to a wild animal has been widely used.

Meanwhile, when the wild animal enters a shadow area where a GPS signal cannot be received, such as a space under a rock, depending on its living environment, it becomes impossible to determine the location of a wild animal and estimate or track the path of the wild animal.

Furthermore, it is important to a terminal attached to a wild animal that cannot be easily captured that the period of use of the battery of the terminal is increased by reducing the consumption of power. Since a mobile communication module corresponds to a wireless communication technology that generally requires high power consumption, a problem occurs in connection with the continuous estimation or tracking of a path.

As a related technology, Korean Unexamined Patent Application Publication No. 10-2013-0122461 entitled “Information Detection System” discloses a technology in which an ubiquitous sensor network is constructed in an area of interest in advance, mall-sized flight vehicles are organized in a formation, and the small-sized flight vehicles collect information from ubiquitous sensor network (USN) sensors on the ubiquitous sensor network while performing their respective roles.

### SUMMARY

At least some embodiments of the present invention are directed to the provision of an apparatus and method for determining the location of a mobile object, which are capable of determining the location of a mobile object in a shadow area where a GPS signal cannot be received, and are also capable of minimizing the power consumption of a location determination terminal attached to the mobile object, thereby enabling the long-term operation of the location determination terminal.

In accordance with an aspect of the present invention, there is provided an apparatus for determining the location of a mobile object, including a GPS module unit configured to receive a GPS signal, including the coordinate information of the current location of a mobile object, from a GPS transmission satellite; a mobile communication module unit configured to be operated when the GPS module unit has received the GPS signal, and to transmit the coordinate information of the current location of the mobile object and the ID of the mobile object to a location estimation apparatus over a mobile communication network; a USN module unit configured to be operated when the GPS module unit fails to receive the GPS signal, and to broadcast a beacon signal carrying the ID of the mobile object; and a control module unit configured to operate any one of the mobile communication module unit and the USN module unit by turning on power thereof depending on whether the GPS module unit has received the GPS signal during a location determination period for the mobile object.

When the location determination period for the mobile object starts, the GPS module unit may wake up for a predetermined period and then sleep on.

When the woken-up GPS module unit has received the GPS signal, the mobile communication module unit may wake up after the sleeping on of the GPS module unit, operate and then sleep on.

When the woken-up GPS module unit has not received the GPS signal, the USN module unit may wake up after the sleeping on of the GPS module unit, operate and then sleep on.

The beacon signal of the USN module unit may be broadcast to a flight vehicle flying over a shadow area for the location determination period for the mobile object.

When receiving the beacon signal, the flight vehicle may transmit information about the shadow area and the ID of the mobile object to the location estimation apparatus over the mobile communication network.

The GPS module unit, the mobile communication module unit, the USN module unit, and the control module unit may be attached to the mobile object.

In accordance with another aspect of the present invention, there is provided an apparatus for determining the location of a mobile object, including a USN module unit configured to receive a beacon signal, carrying the ID of a corresponding mobile object, from a mobile object terminal; a mobile communication module unit configured to, when the USN module unit has received the beacon signal, transmit information about a corresponding shadow area and the ID of the mobile object to a location estimation apparatus over a mobile communication network; and a control module unit configured to perform control so that the operations of the USN module unit and the mobile communication module unit are performed during a location determination period for the mobile object.

The beacon signal may be broadcast by the mobile object terminal within the shadow area for the location determination period for the mobile object.

During the location determination period for the mobile object, the control module unit may wake up the USN module unit for a predetermined period and then allow the USN module unit to sleep on.

When the woken-up USN module unit has received the beacon signal, the control module unit may allow the USN module unit to sleep on and then wake up the mobile communication module unit.

After the woken-up mobile communication module unit has transmitted the information about the corresponding shadow area and the ID of the mobile object, the control module unit may allow the mobile communication module unit to sleep on.

The USN module unit, the mobile communication module unit, and the control module unit may be installed in a flight vehicle.

In accordance with still another aspect of the present invention, there is provided a method of determining the location of a mobile object, including receiving, by a GPS module unit inside a mobile object terminal, a GPS signal, including the coordinate information of the current location of a mobile object, from a GPS transmission satellite; operating a mobile communication module unit inside the mobile object terminal when the GPS signal has been received upon receiving the GPS signal, and transmitting, by the mobile communication module unit, the coordinate information of the current location of the mobile object and the ID of the mobile object to a location estimation apparatus over a mobile communication network; and operating a USN module unit inside the mobile object terminal when the GPS signal has not been received upon receiving the GPS signal, and broadcasting, by the USN module unit, a beacon signal carrying the ID of the mobile object.

Receiving the GPS signal may be performed while the GPS module unit wakes up for a predetermined period and then sleeps on when the location determination period for the mobile object starts.

Transmitting the coordinate information of the current location of the mobile object and the ID of the mobile object may be performed while the mobile communication module unit wakes up after the sleeping on of the GPS module unit, operates and then sleeps on when the woken-up GPS module unit receives the GPS signal.

Broadcasting the beacon signal may be performed while the USN module unit wakes up after the sleeping on of the GPS module unit, operates and then sleeps on when the woken-up GPS module unit has not received the GPS signal.

Broadcasting the beacon signal may include broadcasting the beacon signal to a flight vehicle flying over a shadow area for the location determination period for the mobile object.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a system for determining the location of a mobile object according to an embodiment of the present invention;

FIG. 2 is a diagram illustrating the internal configuration of the mobile object terminal illustrated in FIG. 1;

FIG. 3 is a diagram illustrating the internal configuration of the flight vehicle illustrated in FIG. 1;

FIG. 4 is a flowchart illustrating the operation of a mobile object terminal in a method of determining the location of a mobile object according to an embodiment of the present invention; and

FIG. 5 is a flowchart illustrating the operation of a flight vehicle in a method of determining the location of a mobile object according to an embodiment of the present invention.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

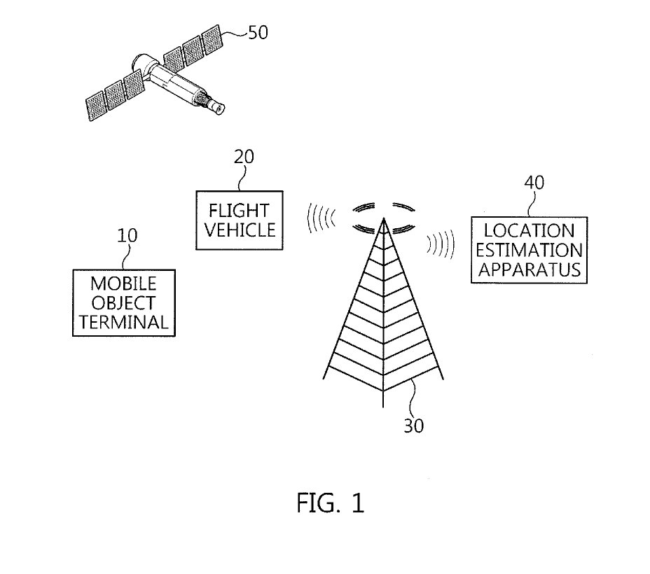

FIG. 1 is a diagram illustrating the configuration of a system for determining the location of a mobile object according to an embodiment of the present invention.

A system for determining the location of a mobile object according to an embodiment of the present invention includes a mobile object terminal 10 and a flight vehicle 20. Each of the mobile object terminal 10 and the flight vehicle 20 that are described below may be examples of an apparatus for determining the location of a mobile object that is described in the accompanying claims.

The mobile object terminal 10 is attached to a mobile object (for example, a wild animal). The mobile object terminal 10 has been assigned a unique ID that is used to identify a mobile object to which the corresponding mobile object terminal 10 has been attached.

In this case, the mobile object terminal 10 receives a GPS signal (for example, including the coordinate information of the current location of the mobile object) from a GPS transmission satellite 50 in an area where a GPS signal can be received, and transmits the received coordinate information and an ID (that is, the ID of the mobile object terminal) to a location estimation apparatus 40 through a base station 30 over a mobile communication network. In this case, the ID of the mobile object terminal may be viewed as the ID of the mobile object attached to the corresponding mobile object terminal.

In contrast, when the mobile object terminal 10 is located in a shadow area in which a GPS signal cannot be received from the GPS transmission satellite 50, the mobile object terminal 10 transmits a beacon signal including the ID for a predetermined period. In this case, a communication method that is used to perform the transmission may be implemented using a short-distance wireless communication method or a ubiquitous sensor network (USN) method.

The flight vehicle 20 receives a beacon signal from the mobile object terminal 10 while conducting a surveillance flight over a shadow area within an observation area during a period in which the mobile object terminal 10 transmits location information (coordinate information). When receiving the beacon signal, the flight vehicle 20 transmits information about the corresponding shadow area (for example, including the location information of the corresponding shadow area) and the ID of the mobile object terminal 10 to the location estimation apparatus 40.

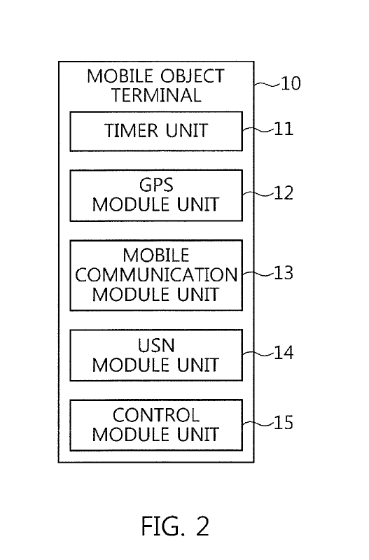

FIG. 2 is a diagram illustrating the internal configuration of the mobile object terminal illustrated in FIG. 1.

The mobile object terminal 10 includes a timer unit 11, a GPS module unit 12, a mobile communication module unit 13, a USN module unit 14, and a control module unit 15.

The timer unit 11 counts time. In particular, the time counting of the timer unit 11 is required to determine whether the preset location determination period of the mobile object starts. The location determination period of the mobile object may be previously set to, for example, a period from 00:05:00 to 00:07:00, a period from 13:05:00 to 13:07:00, or the like. In this case, the preset location determination period of the mobile object is stored in the control module unit 15. Meanwhile, the preset location determination period of the mobile object may be adjusted as required.

The GPS module unit 12 receives a GPS signal (including the coordinate information of the current location of the mobile object) from the GPS transmission satellite 50.

The mobile communication module unit 13 operates when the GPS module unit 12 succeeds in receiving a GPS signal. The mobile communication module unit 13 transmits the coordinate information of a current location (that is, the coordinate information of the current location of the mobile object), received from the GPS module unit 12, and the ID of the mobile object terminal 10 to the location estimation apparatus 40 through the base station 30 via the mobile communication network.

The USN module unit 14 operates if the GPS module unit 12 fails to receive a GPS signal. The USN module unit 14 transmits a beacon signal, carrying the ID of the mobile object terminal 10, to the flight vehicle 20 for a specific period in a broadcast manner.

The location determination period of the mobile object (for example, a wild animal) has been previously set in the control module unit 15.

Furthermore, the control module unit 15 stores the ID of the mobile object terminal 10.

The control module unit 15 determines whether a location determination period for a mobile object (for example, a wild animal) has started based on a counted value from the timer unit 11, and, if the location determination period for a mobile object has started, operates the long-distance wireless communication mobile communication module unit 13 or the short-distance wireless communication USN module unit 14 responsible for the transmission of location information depending on whether a GPS signal has been received from the GPS module unit 12 by turning on the power thereof. In this case, when the mobile communication module unit 13 or the USN module unit 14 is operated by turning on the power thereof, the control module unit 15 provides the ID of the mobile object terminal 10 to the module unit that is currently being operated.

Although the timer unit 11 and the control module unit 15 have been illustrated as being separate components in the above-described FIG. 2, the timer unit 11 may be included in the control module unit 15.

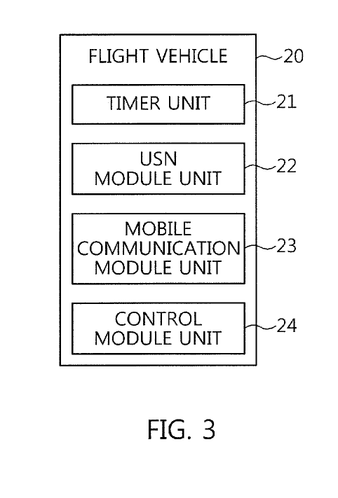

FIG. 3 is a diagram illustrating the internal configuration of the flight vehicle illustrated in FIG. 1.

The flight vehicle 20 includes a timer unit 21, a USN module unit 22, a mobile communication module unit 23, and a control module unit 24.

The timer unit 11 counts time. In particular, the time counting of the timer unit 11 is required to determine whether the preset location determination period of the mobile object starts. The location determination period of the mobile object may be previously set to, for example, a period from 00:05:00 to 00:07:00, a period from 13:05:00 to 13:07:00, or the like.

The timer unit 21 counts time. In particular, the time counting of the timer unit 21 is required to determine whether the preset flight period of the flight vehicle 20 has started. The flight period of the flight vehicle 20 may be previously set to, for example, a period from 00:05:00 to 00:07:00, a period from 13:05:00 to 13:07:00, or the like. As a result, the flight period of the flight vehicle 20 may be viewed as being the same as the location determination period of the mobile object. Accordingly, it is preferred that the time counted value of the timer unit 21 is the same as the time counted value of the timer unit 11. This is intended to enable the mobile object terminal 10 and the flight vehicle 20 to be operated together for the location determination period or flight period that is the same as the location determination period.

The USN module unit 22 receives a beacon signal from the USN module unit 14 of the mobile object terminal 10.

When the USN module unit 22 has succeeded in receiving the beacon signal, the mobile communication module unit 23 is operated. The mobile communication module unit 23 that has succeeded in receiving the beacon signal transmits information about a corresponding shadow area (for example, including the location information of the corresponding shadow area) and the ID of the mobile object terminal 10 to the location estimation apparatus 40 via the base station 30 over the mobile communication network.

The flight period of the flight vehicle 20 (corresponding to the location determination period of the mobile object), a flight area, etc. may be preset in the control module unit 24. The control module unit 24 determines whether the flight period of the flight vehicle 20 has started based on a counted value from the timer unit 11, and allows a flight to be made across the flight area including a shadow area for the flight period of the flight vehicle 20. Furthermore, the control module unit 24 enables a beacon signal to be received by waking up the USN module unit 22 while a flight is being made in the sky above the shadow area for the location determination period of the mobile object (corresponding to the flight period of the flight vehicle 20). When the USN module unit 22 has received the beacon signal, the control module unit 24 allows the USN module unit 22 to sleep on, and operates the mobile communication module unit 23 by waking up it.

Although the timer unit 21 and the control module unit 24 have been illustrated as being separate components in the above-described FIG. 3, the timer unit 21 may be included in the control module unit 24.

Meanwhile, although not illustrated in the diagrams, the flight vehicle 20 may be any type of flight vehicle as long as the flight vehicle is provided with flight-enabling equipment.

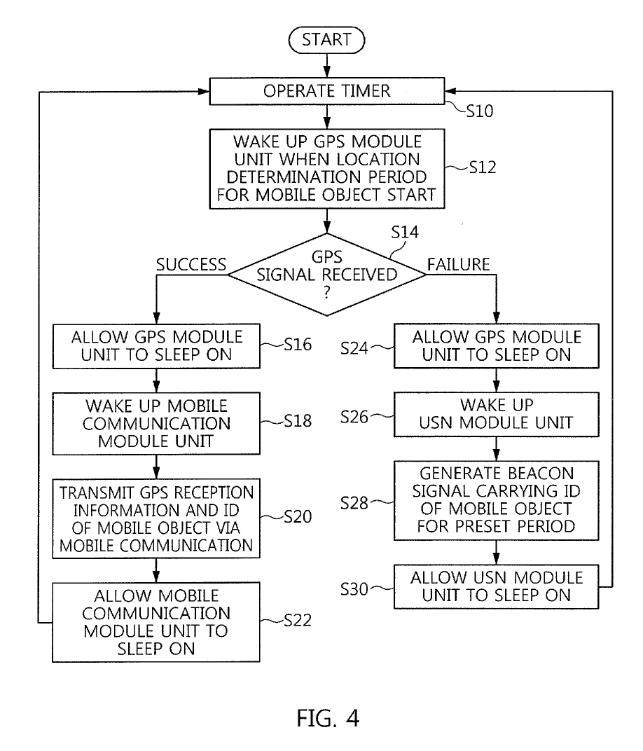

FIG. 4 is a flowchart illustrating the operation of a mobile object terminal in a method of determining the location of a mobile object according to an embodiment of the present invention.

The timer unit 11 of the mobile object terminal 10 is operated and counts time at step S10.

At step S12, the counted value of the timer unit 11 is applied to the control module unit 15 in real time, and the control module unit 15 wakes up the GPS module unit 12 if the counted value of the timer unit 11 reaches the location determination period of the mobile object. In this case, the waking up means operating a module or a device in a sleep state in which the module or device is not being operated. Furthermore, for the location determination period of the mobile object, the flight vehicle 20 makes a flight in the sky over the shadow area (i.e., an area in which a GPS signal is not received). Moreover, the wakeup period of the GPS module unit 12 may be about a few seconds or minutes.

When the GPS module unit 12 is operated, the control module unit 15 determines whether the GPS module unit 12 has received a GPS signal from the GPS transmission satellite 50 at step S14.

If, as a result of the determination, it is determined that the GPS module unit 12 has received a GPS signal from the GPS transmission satellite 50, the control module unit 15 allows the corresponding GPS module unit 12 to sleep on at step S16. Thereafter, the control module unit 15 wakes up the mobile communication module unit 13 at step S18.

The mobile communication module unit 13 waked up as described above transmits GPS reception information (for example, the coordinate information of the current location of the mobile object) from the GPS module unit 12 and the ID of the mobile object terminal 10 to the location estimation apparatus 40 via the base station 30 over the mobile communication network at step S20.

Thereafter, the control module unit 15 allows the mobile communication module unit 13 to sleep on at step S22.

Meanwhile, if, as a result of the determination at step S14, it is determined that the GPS module unit 12 has not received a GPS signal from the GPS transmission satellite 50, the control module unit 15 allows the GPS module unit 12 to sleep on at step S24. Thereafter, the control module unit 15 wakes up the USN module unit 14 at step S26.

The USN module unit 14 woken up as described above outputs a beacon signal carrying the ID of the mobile object terminal 10 to the outside for a predetermined period in a broadcast manner at step S28.

Thereafter, the control module unit 15 allows the USN module unit 14 to sleep on at step S30.

The reason for performing the operations of waking up the GPS module unit 12, the mobile communication module unit 13 and the USN module unit 14 and allowing them to sleep on depending on situations as described above is to save standby power that is consumed while the corresponding communication module is being kept turned on.

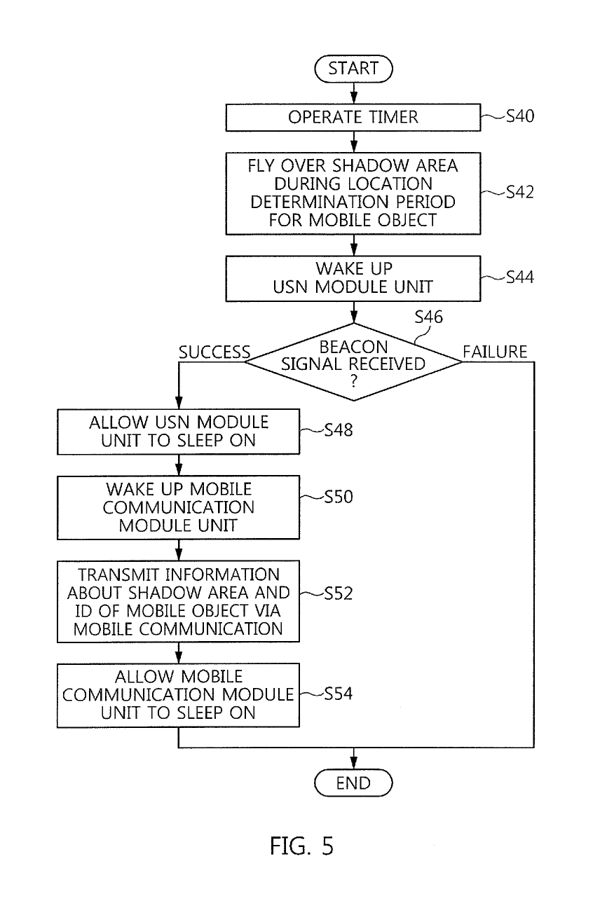

FIG. 5 is a flowchart illustrating the operation of a flight vehicle in a method of determining the location of a mobile object according to an embodiment of the present invention.

The timer unit 21 of the flight vehicle 20 is operated and counts time at step S40.

At step S42, the counted value of the timer unit 21 is applied to the control module unit 24 in real time, and the flight vehicle 20 makes a flight in the sky over a shadow area (i.e., an area where a GPS signal is not received) for the location determination period of a mobile object if the counted value of the timer unit 21 reaches the location determination period of the mobile object (corresponding to the flight period of the flight vehicle).

Thereafter, the control module unit 24 wakes up the USN module unit 22 in a sleep-on state at step S44. Accordingly, the woken up USN module unit 22 receives a beacon signal from the mobile object terminal 10. In this case, the wakeup period of the USN module unit 22 may be about a few seconds or minutes.

When the USN module unit 22 has received the beacon signal from the mobile object terminal 10 (“success” at step S46) as described above, the control module unit 24 allows the USN module unit 22 to sleep on at step S48, and wakes up the mobile communication module unit 23 at step S50.

The mobile communication module unit 23 woken up as described above transmits information about a corresponding shadow area (for example, including the location information of the corresponding shadow area) and the ID of the mobile object terminal 10 to the location estimation apparatus 40 via the base station 30 over the mobile communication network at step S52.

Thereafter, the control module unit 24 allows the mobile communication module unit 23 to sleep on at step S54.

The reason for performing the operations of waking up the USN module unit 22 and the mobile communication module unit 23 and allowing them to sleep on depending on situations as described above is to save standby power that is consumed while the corresponding communication module is being kept turned on.

At least one embodiment of the present invention has the advantage of transmitting location information for the estimation or tracking of a location to the location estimation apparatus during a preset period while reducing the amount of use of a battery.

That is, the present invention has the advantage of reducing the amount of use of a battery while reducing the probability of the failure of the estimation or tracking of a location.

The mobile object terminal receives a GPS signal for a preset period, and selects and turns on a transmission module depending on whether a GPS signal has been received. This control is performed to save standby power that is consumed while the communication module is being kept turned on.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. An apparatus for determining a location of a mobile object, comprising:
a global positioning system (GPS) module unit configured to receive a GPS signal, including coordinate information of a current location of a mobile object, from a GPS transmission satellite;
a mobile communication module unit configured to be operated when the GPS module unit has received the GPS signal, and to transmit the coordinate information of the current location of the mobile object and an identification (ID) of the mobile object to a location estimation apparatus over a mobile communication network;
a ubiquitous sensor network (USN) module unit configured to be operated when the GPS module unit fails to receive the GPS signal, and to broadcast a beacon signal carrying the ID of the mobile object; and
a control module unit configured to operate any one of the mobile communication module unit and the USN module unit by turning on power thereof depending on whether the GPS module unit has received the GPS signal during a location determination period for the mobile object.

2. The apparatus of claim 1, wherein when the location determination period for the mobile object starts, the GPS module unit wakes up for a predetermined period and then sleeps on.

3. The apparatus of claim 2, wherein when the woken-up GPS module unit has received the GPS signal, the mobile communication module unit wakes up after the sleeping on of the GPS module unit, operates, and then sleeps on.

4. The apparatus of claim 2, wherein when the woken-up GPS module unit has not received the GPS signal, the USN module unit wakes up after the sleeping on of the GPS module unit, operates, and then sleeps on.

5. The apparatus of claim 1, wherein the beacon signal of the USN module unit is broadcast to a flight vehicle flying over a shadow area for the location determination period for the mobile object.

6. The apparatus of claim 5, wherein when receiving the beacon signal, the flight vehicle transmits information about the shadow area and the ID of the mobile object to the location estimation apparatus over the mobile communication network.

7. The apparatus of claim 1, wherein the GPS module unit, the mobile communication module unit, the USN module unit, and the control module unit are attached to the mobile object.

8. An apparatus for determining a location of a mobile object, comprising:
a USN module unit configured to receive a beacon signal, carrying an ID of a corresponding mobile object, from a mobile object terminal;
a mobile communication module unit configured to, when the USN module unit receives the beacon signal, transmit information about a corresponding shadow area and an ID of the mobile object to a location estimation apparatus over a mobile communication network; and
a control module unit configured to perform control so that operations of the USN module unit and the mobile communication module unit are performed during a location determination period for the mobile object.

9. The apparatus of claim 8, wherein the beacon signal is broadcast by the mobile object terminal within the shadow area for the location determination period for the mobile object.

10. The apparatus of claim 8, wherein during the location determination period for the mobile object, the control module unit wakes up the USN module unit for a predetermined period and then allows the USN module unit to sleep on.

11. The apparatus of claim 10, wherein when the woken-up USN module unit has received the beacon signal, the control module unit allows the USN module unit to sleep on and then wakes up the mobile communication module unit.

12. The apparatus of claim 11, wherein after the woken-up mobile communication module unit has transmitted the information about the corresponding shadow area and the ID of the mobile object, the control module unit allows the mobile communication module unit to sleep on.

13. The apparatus of claim 8, wherein the USN module unit, the mobile communication module unit, and the control module unit are installed in a flight vehicle.

14. A method of determining a location of a mobile object, comprising:
receiving, by a GPS module unit inside a mobile object terminal, a GPS signal, including coordinate information of a current location of a mobile object, from a GPS transmission satellite;
operating a mobile communication module unit inside the mobile object terminal when the GPS signal has been received upon receiving the GPS signal, and transmitting, by the mobile communication module unit, the coordinate information of the current location of the mobile object and an ID of the mobile object to a location estimation apparatus over a mobile communication network; and
operating a USN module unit inside the mobile object terminal when the GPS signal has not been received upon receiving the GPS signal, and broadcasting, by the USN module unit, a beacon signal carrying the ID of the mobile object.

15. The method of claim 14, wherein receiving the GPS signal is performed while the GPS module unit wakes up for a predetermined period and then sleeps on when the location determination period for the mobile object starts.

16. The method of claim 15, wherein transmitting the coordinate information of the current location of the mobile object and the ID of the mobile object is performed while the mobile communication module unit wakes up after the sleeping on of the GPS module unit, operates and then sleeps on when the woken-up GPS module unit receives the GPS signal.

17. The method of claim 15, wherein broadcasting the beacon signal is performed while the USN module unit wakes up after the sleeping on of the GPS module unit, operates and then sleeps on when the woken-up GPS module unit has not received the GPS signal.

18. The method of claim 14, wherein broadcasting the beacon signal comprises broadcasting the beacon signal to a flight vehicle flying over a shadow area for the location determination period for the mobile object.
